(19) United States
(12) Patent Application Publication
(10) Pub. No.: US 2008/0229353 A1
(43) Pub. Date: Sep. 18, 2008

(54) Providing context-appropriate advertisements in video content

(75) Inventors: Ronald A. Morris, San Francisco, CA (US); Peter Barrett, San Francisco, CA (US); David Sloo, Menlo Park, CA (US); Ted Ludvig, Redwood City, CA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/716,898

(22) Filed: Mar. 12, 2007

(51) Int. Cl. H04N 7/10

(52) U.S. Cl. 725/32

(57) ABSTRACT

Detailed herein is a technology which, among other things, allows integration of context-relevant advertisements with non-real-time video playback. In one approach to this technology, context information related to video content is determined, and used to select advertisements which are contextually related to video content. These advertisements can then be integrated into the video presentation in a number of ways.

### BACKGROUND

Advances in technology have affected traditional forms of advertisement. In particular, the development of new technology for time-shifting and viewing television broadcasts and motion pictures in the home has impacted the effectiveness of the venerable commercial break. Significant research efforts go into determining what demographic is likely to be watching what show, and therefore when best to advertise particular product. Those efforts are wasted, to an extent, when substantial portions of the audience are time-shifting the program, and coincidentally avoiding the commercials.

In some cases, potential customers are missing advertisements for products that they would otherwise be interested in, simply because they are fast forwarding or otherwise skipping traditional advertisements in a digitally recorded broadcast. Additionally, development and distribution of video on demand (VOD) systems present a new opportunity to expose potential customers to products they may be interested in.

### SUMMARY

Detailed herein is a technology which, among other things, allows integration of context-relevant advertisements with non-real-time video playback. In one approach to this technology, context information related to video content is determined, and used to select advertisements which are contextually related to video content. These advertisements can then be integrated into the video presentation in a number of ways.

In another approach, a digital media player with an input module, a user interface module, a playback module, and an output module is utilized. The user interface module allows for selection of content from some content provider through an interface available to a user. The user interface module can also display an indicator of the presence of a context-relevant store. The user can then access this context-relevant store.

Another approach to technology allows the integration of contextually-relevant advertisements into video playback. An ad request is received from a digital media player, with information about video content. With reference to that ad request, an advertisement can be selected, and transmitted to the digital media player.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

The accompanying drawings, which are incorporated in and form a part of this specification, illustrate embodiments and, together with the description, serve to explain the principles of the claimed subject matter:

FIG. 1 is a block diagram of an exemplary digital media player, upon which embodiments may be implemented.

FIG. 2 is a diagram of a video on demand (VOD) network, in accordance with one embodiment.

FIG. 3 is a diagram of a personal video recorder (PVR) system, in accordance with one embodiment.

FIG. 4 is a flowchart of a method of integrating a context-appropriate advertisement, in accordance with one embodiment.

FIG. 5 is a flowchart of a method of accessing a context-relevant store, in accordance with one embodiment.

FIG. 6 is a flowchart of a method of displaying contextually appropriate ads, in accordance with one embodiment.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

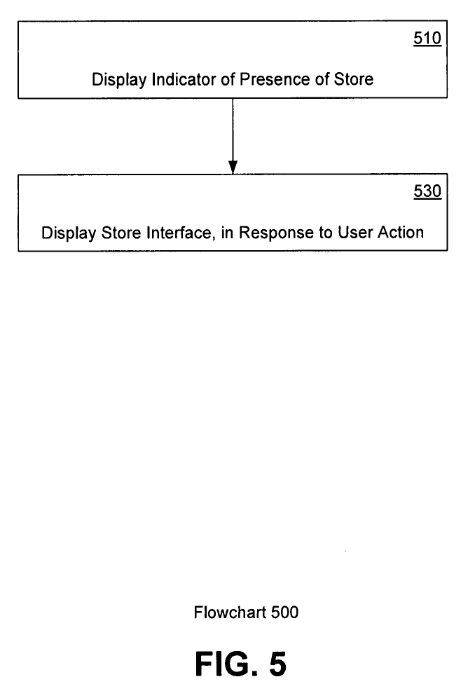

Portions of the detailed description that follows are presented and discussed in terms of a method. Although steps and sequencing thereof are disclosed in a figure herein (e.g., FIG. 5) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices, such as digital media player 100, typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage, such as a hard disk drive or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### Targeted and Addressable Advertising

Several types of targeted advertising are utilized, in order to aid in matching an audience with advertisements for products they would be interested in. One such targeted method is contextual advertising, where advertisements are selected that are related to the context of the content being viewed, e.g., ads for products or services which are used in a particular television series, or ads that have been sold into a particular customer profile, associated with the content being viewed. Another targeted method is demographic targeting, where information about the specific audience is used to select advertisements for products or services likely to appeal to the audience, such as can be derived from a subscriber's billing information, e.g., what zip code they live in, or by cross-referencing billing information with other databases that reflect the user's interests, e.g., grocery store membership card records. As described below, embodiments of the present invention use either contextual targeting, or a combination of both contextual and demographic targeting, in order to select advertisements relevant to the content.

In several of the embodiments described herein, an approach to addressable advertising is described, wherein advertisers have the opportunity to provide information to consumers watching non-real-time video content in a manner beyond the traditional commercial break. In several such embodiments, context relevant advertisements are selected and delivered to the consumer, and integrated seamlessly into the presentation of the video content. These context relevant advertisements are selected based upon information, e.g., metadata, associated with the content itself. In other embodiments, the consumer is given the ability to access additional information about a product appearing in the content he is viewing, and possibly to purchase the product directly.

### Digital Media Player

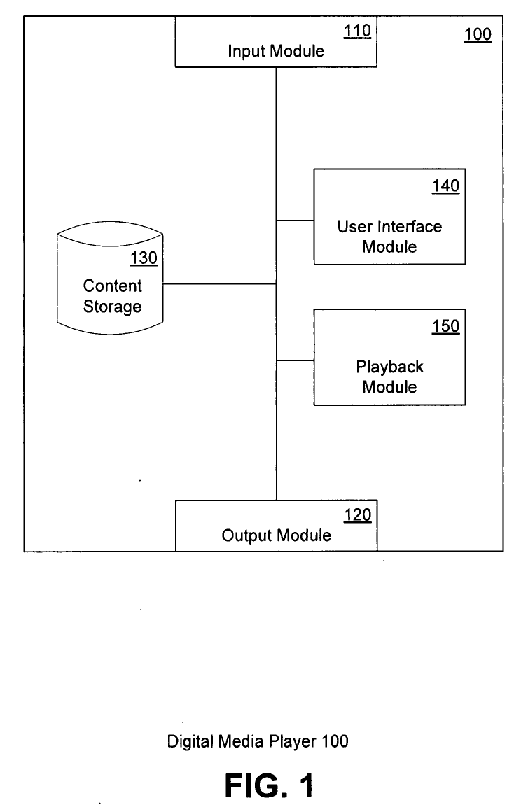

With reference now FIG. 1, a digital media player 100 is depicted, in accordance with one embodiment. While digital media player 100 is shown as incorporating specific, enumerated features, it is understood that embodiments are well suited for use with additional, fewer, or different elements.

Digital media player 100 is shown as including an input module 110, an output module 120, a content storage device 130, a user interface module 140, and a playback module 150.

In the depicted embodiment, input module 110 allows data to enter digital media player 100 from an outside source. In one embodiment, where digital media player 100 is a digital video recorder (DVR) or a personal video recorder (PVR), input module 110 encompasses both receiving television channels and communicating with a programming guide data server. In another embodiment, where digital media player 100 is a set-top receiver for a video on demand (VOD) service, input module 110 is used to communicate with a VOD session manager or VOD metadata server, as well as to receive any services delivered to the receiver. In some embodiments, input module 110 may also allow a user to interact with digital media player 100, e.g., through the use of an infrared remote control device. In other embodiments, a separate receiver module, not shown, may be used to interact with the user.

As shown in FIG. 1, output module 120 is used to both provide feedback to a user of digital media player 100 and to output the content being viewed. In some embodiments, for example, output module 120 includes an output port corresponding to one of the standard television protocols.

Digital media player 100 is also shown as including content storage device 130. Content storage device 130 will vary in nature across different embodiments. In one embodiment, for example, content storage device 130 may consist of one or more hard disk drives; in another embodiment, content storage device 130 may consist of only a small amount of flash memory, used to buffer a streaming video signal before it is displayed. In another embodiment, content storage device 130 is remotely located, rather than integrated into digital media player 100, and is accessed through a connection corresponding to a data transfer protocol, e.g., an 802.11g wireless connection to a centralized data storage device.

As depicted, digital media player 100 includes user interface module 140. In some embodiments, user interface module 140 allows interaction with a user of digital media player 100, e.g., through a remote control. User interface module 140 generates a user interface for digital media player 100. In some embodiments, the user would use this user interface to select content to display, as well as configuring options related both to content and to the operation of digital media player 100.

The depicted embodiment of digital media player 100 also includes playback module 150. In some embodiments, playback module 150 decodes the content the user has selected, in order to enable playback. In several embodiments, user interface module 140 and playback module 150 may be combined into a single module.

### Video on Demand Network

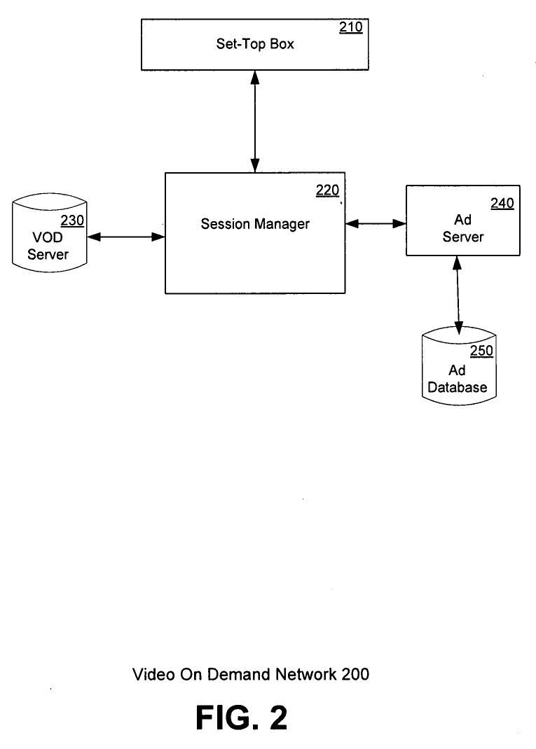

With reference now to FIG. 2, a video on demand (VOD) network 200 is depicted, in accordance with one embodiment. While VOD network 200 is shown as incorporating specific, enumerated features, it is understood that embodiments are well suited for use with additional, fewer, or different elements. Moreover, it is understood that embodiments are well suited to applications besides video on demand services, e.g., PVR interaction.

VOD network 200 is shown as including a set-top box 210, a session manager 220, a VOD server 230, an ad server 240, and an ad database 250.

In the depicted embodiment, set-top box 210 resides at a user's location, e.g., their home. Set-top box 210 allows the user to access various video on demand services, such as selecting from a list of movies to view at a time the user desires to do so, rather than being limited to what is currently being broadcast on a network or cable channel. In one embodiment, set-top box 210 is a digital media player, such as digitally media player 100.

The depicted embodiment shows set-top box 210 communicatively coupled to session manager 220. In some embodiments, session manager 220 is a remote device operated by the user's content provider, e.g., the cable company, and is configured to receive requests for VOD services, and respond to those requests.

VOD server 230, in the depicted embodiment, is accessible to session manager 220. In some embodiments, upon receiving a request for a particular VOD service, session manager 220 accesses VOD server 230, in order to obtain the necessary content.

In the depicted embodiment, VOD network 200 includes ad server 240 and ad database 250. Session manager 220 can access ad server 240 to receive context-appropriate advertisements to transmit to set-top box 210.

### Personal Video Recorder System

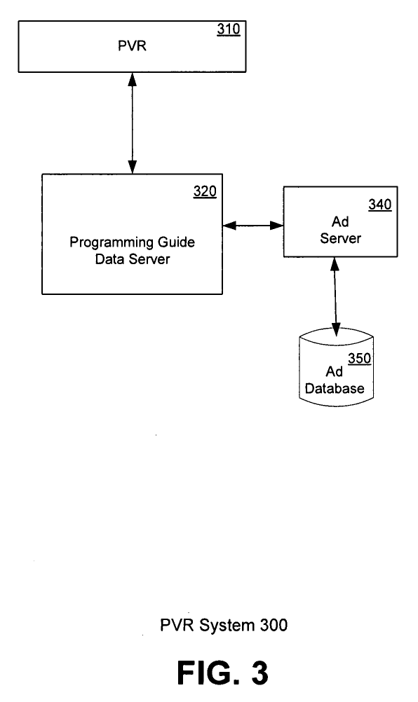

With reference now to FIG. 3, a personal video recorder (PVR) system 300 is depicted, in accordance with one embodiment. While PVR system 300 is shown as incorporating specific, enumerated features, it is understood that embodiments are well suited for use with additional, fewer, or different elements. Moreover, it is understood that embodiments are well suited to applications besides video on demand services, e.g., VOD interaction.

PVR system 300 is shown as including a PVR 310, a programming guide data server 320, an ad server 340, and an ad database 350.

In the depicted embodiment, PVR 310 resides at a user's location, e.g., their residence. In some embodiments, PVR 310 is used to timeshift content received from a content source, e.g., content being received via a satellite dish. In other embodiments, PVR 310 provides additional functionality, e.g., access to VOD services.

As shown, PVR 310 communicates with programming guide data server 320. In the depicted embodiment, programming guide data server server 320 provides a service to PVR 310, e.g., providing programming information, such that a user can easily select which content he wishes to timeshift. In some embodiments, programming guide data server 320 provides additional services, e.g., access to VOD services, or providing content streaming services. Further, in some embodiments, programming guide data server 320 may also provide advertising services for PVR 310.

In the depicted embodiment, PVR system 300 is shown as including ad server 340 and ad database 350. Programming guide data server 320 can access ad server 340 to receive context-appropriate advertisements to transmit to PVR 310.

### Integrating Contextually-Appropriate Ads

One approach to supplying context-specific ads, within the context of a digital media player such as a VOD box or a PVR, is to provide “bumpers”. A bumper ad is one that is placed before or after the desired content. Some embodiments integrate this bumper in such a way so as to make it appear seamless to the user. Numerous other approaches also exists, such as, but not limited to, providing ads when a user is fast forwarding, or has paused playback, or even during the presentation of the content. Similarly, the nature of these ads can vary dramatically, e.g., from single still images to video sequences, or in other ways.

Selecting a context-appropriate ad presents an additional difficulty. In many cases, content includes some form of advertising beyond commercial breaks. One notable example is the concept of product placement, where a particular brand of product is used and identified to the viewer. Over the course of the single film, several such products may be so identified. Over the course of a television series, there is even greater room for product placement.

In selecting an appropriate ad to integrate into the content, the ads already present can be referenced, e.g., ads can be selected for products that appear in the content, in some form, or are otherwise related to the content being viewed. For example, if an action character in a film is depicted as wearing a particular brand of watch, driving a particular brand of car, and enjoying a particular brand of beverage, ads related to those products may be appropriate to integrate into the presentation of the content. Typically, the makers of these products have provided some consideration, in order to have their products highlighted in this matter. Having once so done, the makers may be induced to again provide some consideration, in order to have additional context-related advertisements brought to a viewer's attention.

In some embodiments, determining the context of content can be accomplished through examination of metadata associated with that content. For example, when a video on demand service is requested, metadata associated with that specific service can be examined, to determine the context of the content, e.g., which products are highlighted in that service, and so may be available as a context-appropriate ad. As another example, in the case of a PVR recording, a programming guide data server may access a database, in order to determine the context of a program scheduled for recording. The determination of the context of any particular content will vary, across different embodiments.

In some embodiments, ad selection may be further modified by additional considerations. For example, in some embodiments, demographic data is used to influence the selection of a particular ad. If demographic analysis suggests that the current viewer is a minor, for example, it may be desirable to avoid selecting an ad for an alcoholic beverage. Which factors and analyses will influence this determination will vary across different embodiments. In some other embodiments, other data may influence the selection of a particular ad. For example, the season of the year when recording or playback occurs may help select between several ads with seasonal content. In some embodiments, no additional considerations are utilized.

Once an appropriate ad is selected, it can be integrated into the presentation of the content. This can be accomplished in a wide variety of ways. For example, and not as a limitation, bumper ads can be placed before and after the content. It is desirable, in some embodiments, that the integration of the ads be essentially seamless, from the user's perspective, in such way that the user is not faced with a stand-alone commercial. For example, an ad may appear on the selection screen in the user interface for a video on demand system, while the user is waiting for his movie to start. An ad could appear as a background or wallpaper for an end-of-presentation user interface, after playback of a video has ceased.

In addition to ad bumpers, some embodiments involve a context-appropriate “store.” For example, in the case of the television series, this store may provide access to greater information about some or all products which appear in a particular episode, or over the life of the series. In some embodiments, the store may also allow for purchases. Accessing the store can be accomplished in a variety of ways, in different embodiments. In some embodiments, for example, the user may hit a particular button on his remote control, in order to access the content of the store. In other embodiments, the user may be given the option to access the store before and/or after playback of the content, e.g., as a menu option in the user interface.

In some embodiments, is desirable to provide occasional or periodic reminders to the viewer that this store exists. For example, if a product appears prominently in one particular scene, some unobtrusive reminder, such as a small on-screen display, may indicate to the user that he could find out more about this product by entering the store. In some embodiments, where a user may access the store at any time during the playback of the content, the digital media player involved would be configured to pause playback while the store is being accessed.

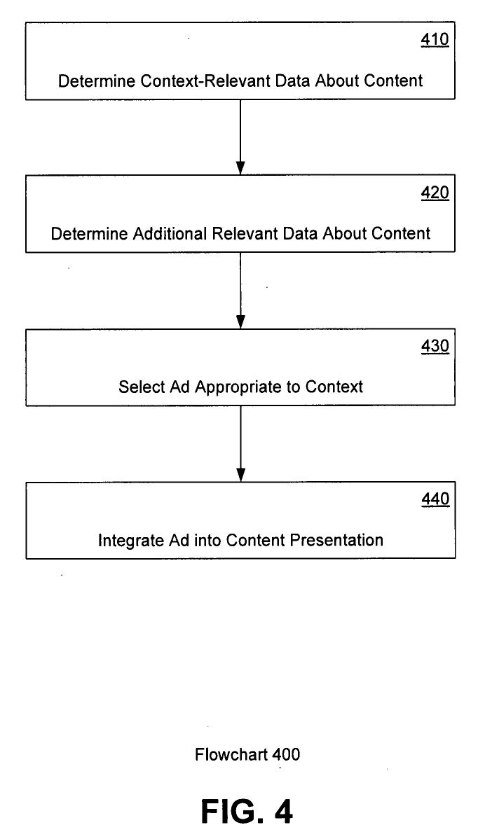

With reference now to FIG. 4, a flowchart 400 of a method of integrating a context-appropriate advertisement is presented, in accordance with one embodiment. Although specific steps are disclosed in flowchart 400, such steps are exemplary. That is, embodiments of the present invention are well suited to performing various other (additional) steps or variations of the steps recited in flowchart 400. It is appreciated that the steps in flowchart 400 may be performed in an order different than presented, and that not all of the steps in flowchart 400 may be performed.

With reference now to step 410, context relevant data about specified content is determined. In some embodiments, this step includes examination of metadata associated with the content. In other embodiments, the step may include accessing a database, which contains context relevant data for a variety of content. In other embodiments, this step may include examining the content itself, to determine the context. In some embodiments, this step may be performed well in advance of playback, e.g., when a particular movie is added to a video on demand service, this step is performed before any customers order that movie. In other embodiments, this step may be performed just prior to playback of the content.

For example, with reference to FIG. 3, when a specified television show, a reality game show, is scheduled for recording on PVR 310, ad server 340 retrieves context relevant data about that television show.

With reference now to step 420, additional relevant information regarding the content is determined. In some embodiments, this step involves analysis of demographic information, e.g., the age, sex, and income level of the likely viewer. In other embodiments, this step involves analysis of other information, e.g., time of day of playback or date of playback. In some embodiments, this step is omitted.

For example, ad server 340 retrieves demographic information associated with PVR 310, such as the number of inhabitants at the residence associated with PVR 310, and their sexes and ages.

With reference now to step 430, an ad appropriate to the content is selected. In some embodiments, this involves selecting an ad for a product or service which appears in the content, as indicated by the context relevant data. Further, this may involve selecting between several such available ads, using some of the additional relevant information to sort between them.

For example, if the context relevant data about the television show indicates that any of six different ads would be appropriate for the context, demographic analysis may indicate that the show is being viewed in a household with a particular household income, which could influence selection of one of those six ads to use as a bumper.

With reference now to step 440, the ad is integrated into the content presentation. As discussed previously, integration of the ad can take a variety of forms, in different embodiments. In some embodiments, for example, advertisements can be placed as bumpers before and/or after the content, and could be still images, backgrounds, or a video. Moreover, in some embodiments, the selected ad or ads could be used to populate a store, where a user could obtain more information about a specific product or service which appeared in the content.

For example, the ad selected could be an ad for a travel agency. A bumper ad could be placed in front of the content, displaying the message “This program brought to you by Our Travel Agency. Stay tuned following this presentation for a valuable offer.” A bumper ad could then be placed at the end of the content, providing the user more information regarding the travel agency, as well as some offer.

### Context-Relevant Store

With reference now to FIG. 5, a flowchart 500 of a method of accessing a context-relevant store is depicted, in accordance with one embodiment. Although specific steps are disclosed in flowchart 500, such steps are exemplary. That is, embodiments of the present invention are well suited to performing various other (additional) steps or variations of the steps recited in flowchart 500. It is appreciated that the steps in flowchart 500 may be performed in an order different than presented, and that not all of the steps in flowchart 500 may be performed.

With reference now to step 510, a reminder of the presence of the store is displayed, in response to the occurrence of a trigger event. In some embodiments, as described above, the store is generated using context-related data associated with the content being displayed. The nature of the trigger event will vary, across different embodiments. In some embodiments, for example, the trigger event could be the appearance of a product on screen, about which more information is available through the store. Such a trigger event could be detected either through embedding information into the content itself, or by obtaining time indicators, along with the context data, indicating when such a trigger event will occur. In some other embodiments, a trigger event could be the end of a normal commercial break in a time-shifted television program, or the user's use of some specified feature of their digital media player, or simply the user pausing playback of the content for some period of time. In some embodiments, access to the store is allowed before and after the content playback, e.g., as a menu option in the content selection process.

For example, a user is playing a movie received through a video on demand service on their set-top box 210. When a particular product appears on screen for the first time, a small reminder that pressing a particular button on the remote control will allow access to more information about this and other featured products appears in the corner of the display.

With reference now to step 520, the store interface is displayed, in response to a user action. The nature of the user action will vary, across different embodiments. In some embodiments, for example, the user may access the store during playback of content, e.g., by pressing a particular button on the remote control. In several other embodiments, the user may access the store after playback of content has been paused or stopped, e.g., by selecting a particular menu option. The nature of the store interface will also vary, across different embodiments. In some embodiments, the interface for the store itself will be relatively small or unobtrusive, e.g., can be overlaid atop a portion of the screen, without blocking all of the content being played, or could be semi-transparent; from this interface, the user can select ads or additional information about various products associated with the content in a context-relevant manner. Such ads may be played back at the time of selection, or the user's interests may simply be noted for future advertisements, e.g., after the content has concluded.

For example, after a movie received through a video on demand service has concluded, the user is provided with a list of relevant options, e.g., repeat playback, return to content selection menu, and view available products. If that latter option is selected, an interface is displayed, allowing the user to select between various products or services related to the content just displayed. Selecting any of those products or services will initiate playback of a short ad, providing more information about the product.

### Method of Displaying Contextually Appropriate Ads

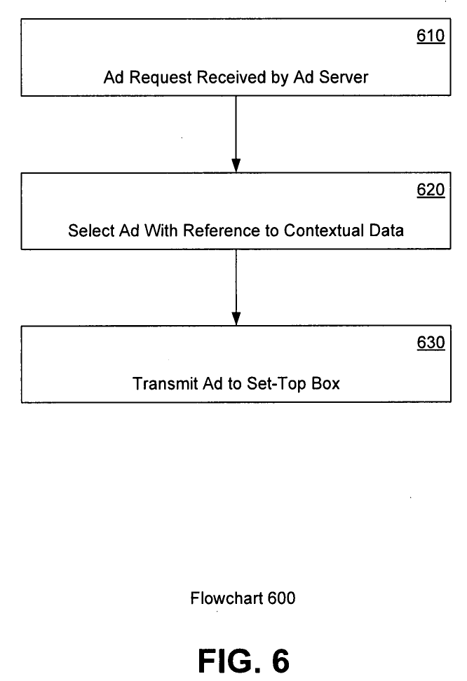

With reference now to FIG. 6, a flowchart 600 of a method of displaying contextually appropriate ads is presented, in accordance with one embodiment. Although specific steps are disclosed in flowchart 600, such steps are exemplary. That is, embodiments of the present invention are well suited to performing various other (additional) steps or variations of the steps recited in flowchart 600. It is appreciated that the steps in flowchart 600 may be performed in an order different than presented, and that not all of the steps in flowchart 600 may be performed.

With reference now to step 610, an ad request is received by an ad server. In some embodiments, such an ad request is generated in response to some user action. The nature of this user action will vary, across different embodiments. In one embodiment, when a user selects an available movie to download, e.g., through a VOD service, an appropriate ad request is transmitted to the ad server. In another embodiment, when a user selects a program to record, e.g., using a PVR, an ad request is transmitted to the ad server. In some embodiments, the step may occur more than once for a single piece of content. For example, when a user initially records a program using a PVR, an ad request is sent. If the user watches the recorded content at a much later time, an additional ad request may be sent, in order to obtain more recent and relevant ads.

The nature of the ad request will similarly vary, across embodiments. In some embodiments, the ad request includes context-specific information, which can be used to help determine an appropriate ad; in other embodiments, the ad request specifies only the name of the content, and context-specific information will have to be obtained from another location.

For example, when a user selects a particular movie to watch through a VOD service, using set-top box 210, an ad request is sent from set-top box 210 to session manager 220. Session manager 220 can then pass the ad request to ad server 240.

With reference now to step 620, an ad is selected. In some embodiments, this ad is selected with reference to contextual data about the content being viewed by the user. In some cases, as noted above, contextual data is included in the ad request, either as transmitted from the user's digital media player, or as passed to the ad server by some intermediary, e.g., a session manager. In other embodiments, the ad server can access contextual information about content in another way, e.g., by connecting to a database. In some embodiments, ad selection may also be influenced by additional considerations, e.g., demographic data or time and date of playback of the content.

For example, ad server 240, in response to the ad request from set-top box 210, uses the context information provided in the ad request about the content being viewed to select an appropriate ad to return to set-top box 210. Ad server 240 can use ad database 250 to retrieve the appropriate ad.

With reference now to step 630, the selected ad is transmitted to the digital media player. The nature of the transmission, as well as the method used to integrate the ad into a user's video presentation, can vary across different embodiments.

For example, ad server 240 transmits the appropriate ad to session manager 220, which integrates into the user's video presentation, for playback on set-top box 210.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of displaying contextually-appropriate ads, comprising:
determining context-relevant data about video content;
selecting an ad, with reference to said context-relevant data; and
integrating said ad into said video content.

2. The method of claim 1, wherein said context-relevant data comprises information about a product appearing in said video content.

3. The method of claim 2, wherein said ad comprises information about said product.

4. The method of claim 1, wherein said integrating comprises placing a bumper ad before playback of said video content.

5. The method of claim 4, wherein said bumper ad comprises a background for a user interface, said user interface for selection of said video content.

6. The method of claim 1, wherein said integrating comprises making said ad available to a user through a selectable store interface.

7. The method of claim 1, wherein said determining comprises examining metadata associated with said video content.

8. The method of claim 1, wherein said determining comprises accessing a database to retrieve said context-relevant data.

9. The method of claim 1, further comprising:
determining additional relevant data about said video content; and
selecting said ad, with reference to said additional relevant data.

10. The method of claim 1, further comprising:
determining demographic information about a likely viewer of said video content; and
selecting said ad, with reference to said demographic information.

11. The method of claim 1, wherein said video content comprises time shifted video content.

12. The method of claim 1, wherein said video content comprises a movie delivered via a video on demand service.

13. A digital media player, comprising:
an input module, for communicating with a content provider;
a user interface module, coupled to said input module, for generating an interface, said interface allowing a user to select content available from said content provider;
a playback module, coupled to said input module, for decoding said content; and
an output module, coupled to said playback module, for transmitting said content to a display device,
wherein said user interface module is configured to display an indicator of the presence of a context-relevant store interface, and said user interface module is further configured to display said context-relevant store interface, in response to a user action.

14. The digital media player of claim 13, wherein said user interface module is further configured to display said indicator in response to a trigger event.

15. The digital media player of claim 14, wherein said trigger event comprises an appearance of a product during playback of said content.

16. The digital media player of claim 13, wherein said context-relevant store interface allows access to a context-relevant advertisement for a product.

17. A method of integrating contextually-relevant advertisements into video playback, comprising:
receiving an ad request from a digital media player, said ad request comprising information about video content;
selecting an advertisement with reference to said ad request; and
transmitting said advertisement to said digital media player.

18. The method of claim 17, wherein said ad request is received in response to a user action.

19. The method of claim 18, wherein said user action comprises selecting said video content for playback.

20. The method of claim 17, wherein said ad request further comprises metadata indicating a product advertised in said video content, and said selecting further comprises referencing said metadata.
